(19) United States
(12) Patent Application Publication
(10) Pub. No.: US 2014/0049579 A1
(43) Pub. Date: Feb. 20, 2014

(54) IMAGE FORMING APPARATUS

(71) Applicant: FUJIFILM CORPORATION, Tokyo (JP)

(72) Inventor: Yutaro JINUSHI, Kanagawa (JP)

(73) Assignee: FUJIFILM CORPORATION, Tokyo (JP)

(21) Appl. No.: 13/950,152

(22) Filed: Jul. 24, 2013

(30) Foreign Application Priority Data
Aug. 14, 2012 (JP) 2012-179919

(51) Int. Cl. B41J 2/045

(52) U.S. Cl. CPC B41J 2/0454
USPC 347/18

(57) ABSTRACT

An image forming apparatus disclosed herein includes: a conveying section that is provided in an apparatus main body and conveys a recording medium; a liquid droplet ejection head that ejects liquid droplets onto the recording medium which is conveyed by the conveying section; a dew condensation member that is provided around the liquid droplet ejection head and allows moisture in air to condense thereon; and a discharge section that discharges water droplets, which are condensed onto the dew condensation member, to an outside of the apparatus main body.

### BACKGROUND OF THE INVENTION

1. Field of the Invention

The present invention relates to an ejection-printing-type image forming apparatus.

2. Description of the Related Art

Conventionally, as image forming apparatuses, there have been known liquid-droplet-ejection-printing-type image forming apparatuses that have a liquid droplet ejection head, in which multiple nozzles are arranged, so as to form an image on a recording sheet of paper by conveying the sheet of paper to the liquid droplet ejection head and ejecting droplets of liquids, from nozzles onto the sheet of paper.

In such liquid-droplet-ejecting-printing-type image forming apparatuses, dew condensation may occur on the nozzle surface of the liquid droplet ejection head due to the humidity within the apparatus main body, and the ejection condition of the liquid droplets may be changed.

Therefore, JP-1989-157860A (JP-H01-157860A) discloses an image forming apparatus that inhibits dew condensation on the nozzle surface with a configuration in which a dew condensation member, which condenses moisture around the liquid droplet ejection head, or a moisture absorbent member, which absorbs the moisture, are provided in the vicinity of the nozzle surface of the liquid droplet ejection head.

### SUMMARY OF THE INVENTION

However, in the configuration of JP-1989-157860A (JP-H01-157860A), there is a concern that the absorbed moisture or the condensed water droplets may be vaporized again and dew condensation may occur on the nozzle surface.

The present invention has been made in view of the above situation, and provides an image forming apparatus that inhibits dew condensation on the nozzle surface of the liquid droplet ejection head.

The problem of the present invention is solved by the following means.

According to a first aspect of the present invention, there is provided an image forming apparatus including: a conveying section that is provided in an apparatus main body and conveys a recording medium; a liquid droplet ejection head that ejects liquid droplets onto the recording medium which is conveyed by the conveying section; a dew condensation member that is provided around the liquid droplet ejection head and that allows moisture in air to condense thereon; and a discharge section that discharges water droplets, which are condensed onto the dew condensation member, to an outside of the apparatus main body.

With such a configuration, moisture in air around the liquid droplet ejection head within the apparatus main body is condensed on the dew condensation member which is provided around the liquid droplet ejection head, and thus it is possible to inhibit dew condensation on the nozzle surface of the liquid droplet ejection head. Further, the water droplets condensed on the dew condensation member are discharged to the outside of the apparatus main body by the discharge section, and thus the condensed water droplets are inhibited from remaining on the dew condensation member and being vaporized again. Accordingly, compared with a case where the discharge section is not provided, it is possible to inhibit dew condensation from occurring on the nozzle surface of the liquid droplet ejection head.

According to a second aspect of the present invention, the image forming apparatus of the first aspect may include a drying section that is provided downstream of the liquid droplet ejection head in a conveying direction of the recording medium and dries the recording medium onto which the liquid droplets have been ejected, in which the dew condensation member is provided between the liquid droplet ejection head and the drying section.

With such a configuration, the drying section dries the recording medium onto which the liquid droplets are ejected. In this case, there is a concern that air, which includes moisture vaporized from liquid droplets or the recording medium, may flow into the liquid droplet ejection head in a state where an amount of moisture of the air is larger than that of air on the upstream side of the liquid droplet ejection head in the conveying direction. Consequently, in the second aspect, the dew condensation member may be provided between the liquid droplet ejection head and the drying section. Thereby, before the air, which includes moisture vaporized from liquid droplets or the recording medium, flows up to the liquid droplet ejection head, the moisture in the air can be condensed on the dew condensation member, and can be removed.

According to a third aspect of the present invention, in the image forming apparatus of the second aspect, the dew condensation member may include a plate and a cooling section that cools down the plate, and the discharge section may include a receptacle which receives the water droplets from a surface of the plate and a discharge pipe through which the water droplets in the receptacle are discharged to the outside of the apparatus main body.

With such a configuration, the plate is cooled down by the cooling section, and thus the moisture in air is condensed on the plate. Further, the water droplets, which are condensed on the plate, are received by the receptacle, are discharged to the outside of the apparatus main body through the discharge pipe, and do not become stagnant in the apparatus main body.

According to a fourth aspect of the present invention, the image forming apparatus of the third aspect may further include a wiper that scrapes off the water droplets, which are condensed onto the surface of the plate, and drops the water droplets to the receptacle.

With such a configuration, it is possible to inhibit the condensed water droplets from remaining on the plate and being vaporized again.

According to a fifth aspect of the present invention, the image forming apparatus of the third aspect or fourth aspect may further include an air blowing section that is provided above the plate and blows air on the dew condensation member so as to blow the water droplets, which are condensed onto the dew condensation member, down to the receptacle.

With such a configuration, when the air blowing section blows air after the moisture is condensed on the dew condensation member, the water droplets, which are condensed on the dew condensation member, are blown down to the receptacle. Thereby, it is possible to inhibit the condensed water droplets from remaining on the dew condensation member and being vaporized again.

According to a sixth aspect of the present invention, in the image forming apparatus of any one of the third to fifth aspects, the receptacle may be cooled down by the cooling section, and an outer surface of the receptacle may be covered with a heat insulation material.

With such a configuration, the cooling section not only cools down the plate but also directly cools down the receptacle or indirectly cools down the receptacle through the plate. However, since the outer surface of the receptacle is covered with the heat insulation material, dew condensation do not occur on the surface of the heat insulation material, and thus it is possible to inhibit the water droplets from dropping down.

According to a seventh aspect of the present invention, in the image forming apparatus of any one of the third to sixth aspects, a receiving surface of the receptacle may be inclined, and the discharge pipe may suction the water droplets from a lower portion of the inclined receiving surface by using a pump.

With such a configuration, the water droplets, which are received on the receiving surface, flow and drop down to the lower portion due to the inclination of the receiving surface, and flow toward the discharge pipe. Then, by causing the pump to suction the water droplets flowing toward the discharge pipe, it is possible to promptly discharge the water droplets within the receptacle through the discharge pipe.

According to an eighth aspect of the present invention, the image forming apparatus of any one of the third to seventh aspects may further include a cooling control section that performs switching between start and stop of cooling performed by the cooling section, depending on an amount of liquid droplets ejected from the liquid droplet ejection head or a humidity between the liquid droplet ejection head and the drying section.

With such a configuration, the cooling control section causes the cooling section to start cooling when the amount of liquid droplets or the humidity is higher than a predetermined value. Thereby, the moisture in air is condensed on the dew condensation member. Further, the cooling control section causes the cooling section to stop cooling when the amount of liquid droplets or the humidity is equal to or less than the predetermined value. Thereby, it is possible to prevent the cooling performed by the cooling section from interfering with an increase in temperature of the conveying section which is opposed to the liquid droplet ejection head.

According to a ninth aspect of the present invention, the image forming apparatus of the eighth aspect may further include a temperature sensor between the liquid droplet ejection head and the drying section, in which the cooling control section performs switching between the start and the stop of the cooling performed by the cooling section, depending on the temperature which is detected by the temperature sensor.

With such a configuration, the cooling control section causes the cooling section to start cooling when the temperature detected by the temperature sensor is higher than a predetermined value. Thereby, it is possible to inhibit the nozzle surface of the liquid droplet ejection head from drying due to inflow of high-temperature air from the drying section side to the liquid droplet ejection head side.

Further, the cooling control section causes the cooling section to stop cooling when the temperature detected by the temperature sensor is equal to or less than the predetermined value. Thereby, it is possible to reduce energy consumed in the cooling.

According to a tenth aspect of the present invention, in the image forming apparatus of the eighth or ninth aspect, the conveying section may include a drawing drum that conveys the recording medium by rotating while holding the recording medium, onto which the liquid droplets are ejected by the liquid droplet ejection head, on the outer circumferential surface thereof, a delivery drum to which the recording medium on which drawing has been performed by the drawing drum is transferred, and a drying drum that conveys the recording medium by rotating while holding the recording medium, which is transferred from the delivery drum and is dried by the drying section, on the outer circumferential surface thereof. In addition, the dew condensation member may be provided above the delivery drum on a side of the drawing drum.

With such a configuration, the dew condensation member is provided above the delivery drum on the side of the drawing drum on which the air flowing to the liquid droplet ejection head is concentrated. Hence, it is possible to further condense the moisture in the air, which flows to the liquid droplet ejection head, on the dew condensation member.

According to an eleventh aspect of the present invention, in the image forming apparatus of the tenth aspect, a drum temperature sensor that detects a drum temperature may be provided around the drawing drum or the drying drum, and the cooling control section may perform switching between the start and the stop of the cooling performed by the cooling section, depending on the drum temperature which is detected by the drum temperature sensor.

With such a configuration, the cooling control section causes the cooling section to start cooling for example when the drum temperature of the drawing drum or the drying drum detected by the drum temperature sensor is higher than a predetermined value. Thereby, when the temperature of the body excessively increases, it is possible to cool down the body.

Further, the cooling section stops cooling for example when the drum temperature of the drawing drum or the drying drum detected by the drum temperature sensor is equal to or less than the predetermined value. Thereby, it is possible to reduce energy consumed in the cooling.

According to a twelfth aspect of the present invention, the image forming apparatus of the fourth aspect may further include a wiper control section that performs switching between start and stop of driving of the wiper, depending on an amount of liquid droplets ejected from the liquid droplet ejection head or a humidity between the liquid droplet ejection head and the drying section.

With such a configuration, the wiper control section starts driving the wiper when the amount of liquid droplets or the humidity is higher than a predetermined value. Further, the wiper control section stops driving the wiper when the amount of liquid droplets or the humidity is equal to or less than the predetermined value. Thereby, the wiper is driven when the water droplets are condensed on the dew condensation member. Thus, compared with the case where the wiper is constantly being driven, it is possible to inhibit wear of the wiper.

According to a thirteenth aspect of the present invention, in the image forming apparatus of any one of the second to twelfth aspects, the cooling section may include a coolant passage which is formed inside the plate and through which a coolant flows, an inlet pipe through which the coolant flows from the outside of the plate into the coolant passage, and an outlet pipe through which the coolant flows out from the coolant passage to the outside of the plate.

With such a configuration, the coolant flows through the coolant passage formed inside the plate, thereby cooling down the area from the inside to the surface of the plate.

According to a fourteenth aspect of the present invention, in the image forming apparatus of any one of the first to thirteenth aspects, a plurality of the liquid droplet ejection heads may be arranged in a conveying direction of the recording medium, and dew condensation members that allow moisture in air to condense thereon may also be provided between the plurality of the liquid droplet ejection heads.

With such a configuration, the moisture in air including moisture, which is vaporized immediately after the liquid droplets are ejected by each liquid droplet ejection head, is condensed on the dew condensation member. Therefore, it is possible to further inhibit dew condensation on the nozzle surface of the liquid droplet ejection head.

According to the present invention, it is possible to inhibit dew condensation on the nozzle surface of the liquid droplet ejection head.

### BRIEF DESCRIPTION OF THE DRAWINGS

FIG. 1 is a schematic side view of an entire configuration of an image forming apparatus, which is cut along a vertical plane, as an example of an inkjet recording apparatus according to a first embodiment of the present invention.

FIG. 2 is an enlarged side view of an apparatus main body as a principal part of the inkjet recording apparatus according to the present embodiment.

FIG. 3 is a perspective view of a dew condensation member used in the inkjet recording apparatus according to the first embodiment of the present invention.

FIG. 4 is a principal block diagram illustrating a configuration of a control system of an inkjet recording apparatus according to a second embodiment of the present invention.

FIG. 5 is a flowchart illustrating a flow of a process of a cooling control section executed at predetermined intervals (for example, every 0.1 seconds) in the inkjet recording apparatus according to the second embodiment of the present invention.

FIG. 6 is a perspective view of a dew condensation member used in an image forming apparatus according to a third embodiment of the present invention.

FIG. 7 is an enlarged side view of an apparatus main body as a principal part of an image forming apparatus according to a fourth embodiment of the present invention.

### DESCRIPTION OF THE PREFERRED EMBODIMENTS

### First Embodiment

Hereinafter, referring to the accompanying drawings, an image forming apparatus according to a first embodiment of the present invention will be described in detail. It should be noted that, in the drawings, the members (components) having the same or corresponding functions will be represented by the same reference signs and numerals, and description thereof will be appropriately omitted.

<Overall Configuration>

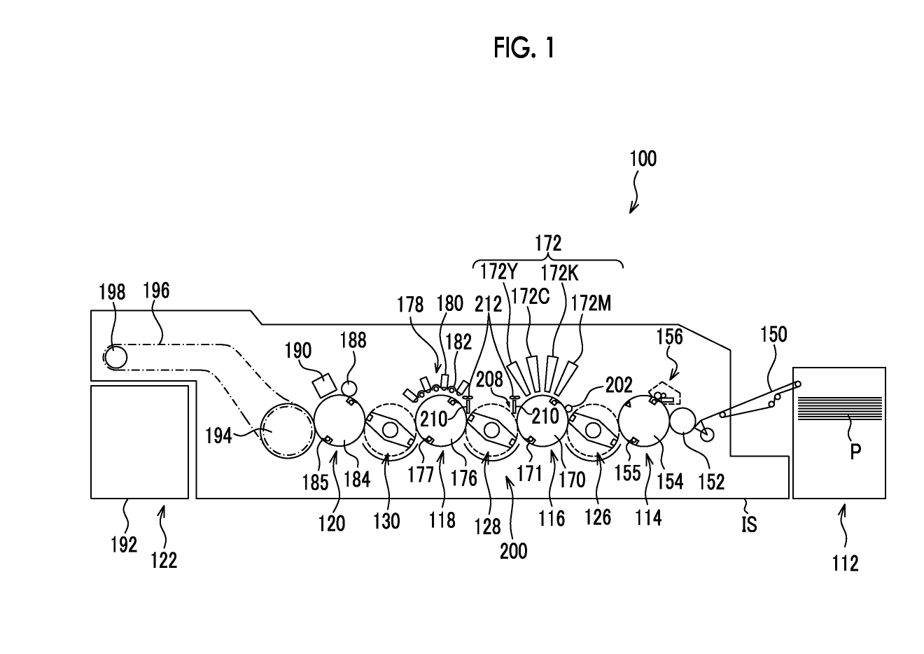

FIG. 1 is a schematic side view of an entire configuration of an inkjet recording apparatus, which is cut along a vertical plane, as an example of an image forming apparatus according to a first embodiment of the present invention.

An inkjet recording apparatus 100 is an impression cylinder direct-drawing type inkjet printing apparatus that forms an image by ejecting a plurality of color inks onto a recording surface of a sheet of paper P, which is held on a drawing drum 170 of a drawing section 116, from inkjet heads 172M, 172K, 172C, and 172Y. Further, the inkjet recording apparatus 100 is an on-demand type image forming apparatus to which a two-liquid reaction (aggregation) method is applied. The two-liquid reaction method forms an image on a sheet of paper P by applying a processing solution (including an aggregating agent which aggregates components in an ink composition) to the sheet of paper P before the ink ejection and making the processing solution and an ink react with each other. It should be noted that hereinafter, all of the inkjet heads 172M, 172K, 172C, and 172Y are simply referred to as “inkjet heads 172”.

The inkjet recording apparatus 100 mainly includes a sheet feeding section 112, a processing solution applying section 114, the drawing section 116, a drying section 118, a fixing section 120, and a sheet discharging section 122.

The sheet feeding section 112 is a mechanism that feeds sheets of paper P to the processing solution applying section 114. The sheets of paper P, which are cut sheets for printing, are stacked in the sheet feeding section 112. The sheet feeding section 112 is provided with a sheet feeding tray 150, and feeds the sheets of paper P one by one from the sheet feeding tray 150 to the processing solution applying section 114.

In the inkjet recording apparatus 100 of the present first embodiment, a plurality of kinds of sheets of paper P having different types or sizes (paper sizes) can be used as the sheets of paper P.

The processing solution applying section 114 is a mechanism that applies the processing solution onto the recording surface of the sheet of paper P. The processing solution contains the aggregating agent that aggregates the components of the ink composition applied by the drawing section 116. When the processing solution comes in contact with the ink, the processing solution and the ink cause the aggregation reaction. As a result, since separation between a solvent and a color material of the ink is facilitated, the ink can be prevented from bleeding or from causing landing interference (mixture) or color mixture after the ink is landed, and thus a high-quality image can be formed.

The processing solution applying section 114 includes a sheet feeding cylinder 152, a processing solution drum 154, and a processing solution coating device 156. The processing solution drum 154 is a drum that holds a sheet of paper P and conveys the sheet of paper P by being rotated. The processing solution drum 154 includes claw-shaped holding means (grippers) 155 on the outer peripheral surface thereof, and holds the leading end of the sheet of paper P by making the sheet of paper P be interposed between the claw of the holding means 155 and the peripheral surface of the processing solution drum 154. Suction holes may be formed on the outer peripheral surface of the processing solution drum 154, and suction means, which performs suctioning from the suction holes, may be connected thereto. Thereby, the sheet of paper P can be closely held on the peripheral surface of the processing solution drum 154.

The processing solution coating device 156 is provided outside the processing solution drum 154 so as to face the peripheral surface thereof. The processing solution is coated on the recording surface of the sheet of paper P by the processing solution coating device 156.

The sheet of paper P, to which the processing solution is applied by the processing solution applying section 114, is delivered from the processing solution drum 154 to the drawing drum 170 of the drawing section 116 through an intermediate conveying section 126 (first delivery drum).

The drawing section 116 includes the drawing drum 170 and inkjet heads 172.

The drawing drum 170 (conveying section) includes claw-shaped holding means (gripper) 171 on the outer peripheral surface thereof similarly to the processing solution drum 154, and the holding means 171 holds and fixes the leading end portion of the recording medium. Further, the drawing drum 170 has a plurality of suction holes formed on the outer peripheral surface, and the sheet of paper P is adhered onto the outer peripheral surface of the drawing drum 170 through a negative pressure. Thereby, the contact between the sheet of paper and the heads caused by floating of the sheet of paper is avoided, and the sheet of paper is prevented from jamming. Further, image unevenness caused by change in clearance from the heads can be prevented.

As described above, the sheet of paper P fixed on the drawing drum 170 is conveyed such that the recording surface faces the outside, and the ink is ejected onto the recording surface from the inkjet head 172 as the liquid droplet ejection head.

Each of the inkjet heads 172M, 172K, 172C, and 172Y (liquid droplet ejection heads) is a full-line type inkjet recording head that has the length corresponding to the maximum width of an image forming area of the sheet of paper P. A nozzle array (the surface of the nozzle array is hereinafter referred to as a nozzle surface), which has a plurality of ink ejection nozzles arranged throughout the entire width of the image forming area, is formed on the ink ejection surface of each of the inkjet heads 172M, 172K, 172C, and 172Y. Each of the inkjet heads 172M, 172K, 172C, and 172Y is installed to extend in a direction orthogonal to the conveying direction of the sheet of paper P (the direction of rotation of the drawing drum 170).

The liquid droplets of the corresponding color ink are ejected from each of the inkjet heads 172M, 172K, 172C, and 172Y onto the recording surface of the sheet of paper P closely held on the drawing drum 170. Thereby, the ink comes in contact with the processing solution applied to the recording surface in advance by the processing solution applying section 114. Then, the color material (pigment) distributed in the ink is aggregated, and a color material aggregate is formed. In such a manner, running of the color material and the like on the sheet of paper P are prevented, and an image is formed on the recording surface of the sheet of paper P.

The drawing section 116 configured as described above is able to draw on the sheet of paper P in a single pass. Thereby, high-speed recording and high-speed output is possible, and productivity can be increased.

The sheet of paper P, on which an image is formed by the drawing section 116, is delivered to a drying drum 176 of the drying section 118 from the drawing drum 170 through an intermediate conveying section 128 (second delivery drum). That is, the drawing drum 170, the intermediate conveying section 128, and the drying drum 176 correspond to the conveying section.

The drying section 118 is a mechanism that dries moisture contained in a solvent separated due to color material aggregation action, and includes the drying drum 176 and a solvent drying device 178 (drying section), as shown in FIG. 1.

The drying drum 176 includes claw-shaped holding means (grippers) 177 on the outer peripheral surface thereof, like the processing solution drum 154, and holds the leading end of the sheet of paper P by the holding means 177. In addition, the outer peripheral surface of the drum has suction holes (not shown in the drawing). With such a configuration, the sheet of paper P can be adhered onto the drying drum 176 by a negative pressure.

The solvent drying device 178 is disposed at the position opposed to the outer peripheral surface of the drying drum 176, and is configured such that a plurality of combinations of a IR heater 182 and a hot-air nozzle 180 is disposed. The temperature and volume of hot air blown toward the sheet of paper P from the hot-air nozzle 180 are appropriately adjusted, thereby achieving various drying conditions. The sheet of paper P is conveyed in a state where the sheet is fixedly adhered onto the outer peripheral surface of the drying drum 176 such that the recording surface thereof faces the outside, and the drying process is performed on the recording surface by using the IR heater 182 and the hot-air nozzle 180.

Further, the drying drum 176 has suction means of which the outer peripheral surface has the suction holes and which performs suctioning through the suction holes. Thereby, the sheet of paper P can be closely held on the peripheral surface of the drying drum 176. Further, by performing negative-pressure suctioning, the sheet of paper P can be fixed onto the drying drum 176, and thus the sheet of paper P can be prevented from cockling.

The sheet of paper P, which is dried by the drying section 118, is delivered to a fixing drum 184 of the fixing section 120 from the drying drum 176 through an intermediate conveying section 130 (third delivery drum).

The fixing section 120 includes the fixing drum 184, a pressing roller 188 (smoothing means), and an in-line sensor 190. The fixing drum 184 includes claw-shaped holding means (grippers) 185 on the outer peripheral surface thereof, like the processing solution drum 154, and is able to hold the leading end of the sheet of paper P by the holding means 185.

The sheet of paper P is conveyed by the rotation of the fixing drum 184 such that the recording surface of the sheet faces the outside, and the inks are fixed onto the recording surface through a smoothing process by a pressing roller 188.

The pressing roller 188 makes the sheet of paper P smooth by pressing the sheet of paper P on which the inks are dried. Further, the in-line sensor 190 measures check patterns, the amount of moisture, the surface temperature, the gloss level, and the like of the sheet of paper P, and may appropriately employ, for example, a CCD line sensor.

The sheet discharging section 122 is provided subsequent to the fixing section 120. The sheet discharging section 122 is provided with a sheet discharging unit 192. A fourth delivery drum 194 and a conveying chain 196 are provided between the fixing drum 184 of the fixing section 120 and the sheet discharging unit 192. The conveying chain 196 is wound around a tensioning roller 198. The sheet of paper P, which passes the fixing drum 184, is sent to the conveying chain 196 through the fourth delivery drum 194, and is delivered from the conveying chain 196 to the sheet discharging unit 192.

In addition, in the above-mentioned configuration of the inkjet recording apparatus 100, an apparatus main body 200 is formed of the processing solution applying section 114, the drawing section 116, the drying section 118, and the fixing section 120. Further, “the inside of the apparatus main body 200” to be described later means a space including the processing solution applying section 114, the drawing section 116, the drying section 118, and the fixing section 120. Furthermore, “the outside of the apparatus main body 200” means not only the outside of the inkjet recording apparatus 100 but also a space, such as a separate space isolated from the space inside the inkjet recording apparatus 100, that has no effect on dew condensation on the nozzle surface of the inkjet head 172.

<Details of Apparatus Main Body 200>

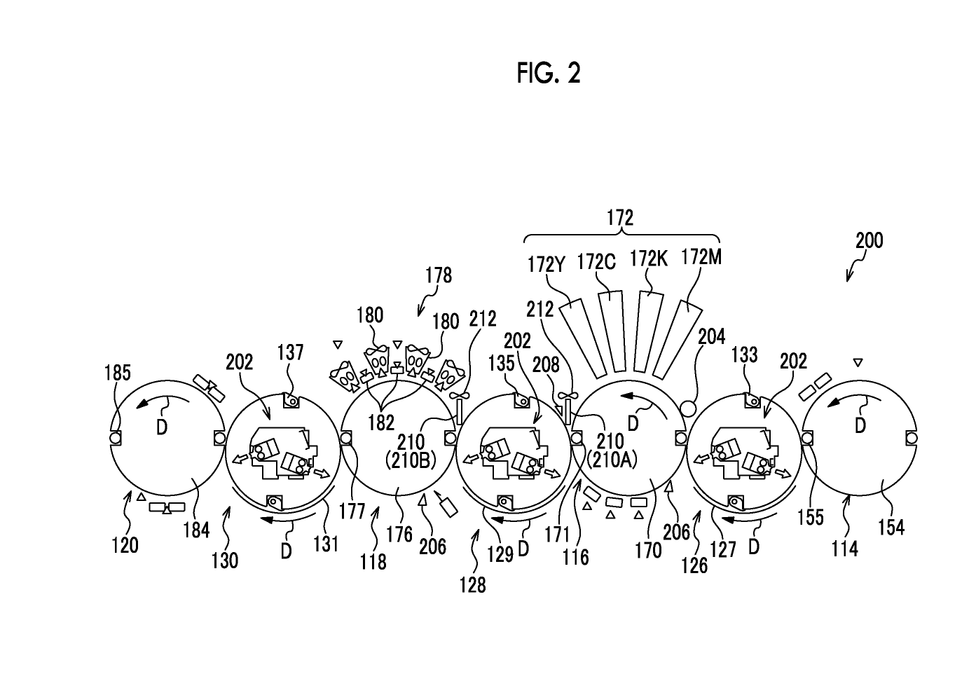

FIG. 2 shows the apparatus main body 200, which is a principal section of the inkjet recording apparatus 100 of the embodiment, in an enlarged manner, and the apparatus main body 200 will be described in further detail.

As shown in FIG. 2, in the apparatus main body 200, the processing solution drum 154, the intermediate conveying section 126 (first delivery drum), the drawing drum 170, the intermediate conveying section 128 (second delivery drum), the drying drum 176, the intermediate conveying section 130 (third delivery drum), and the fixing drum 184 are arranged. In the apparatus main body 200, the sheet of paper P is conveyed by the respective drums, and during the conveying operation, processing solution applying, drawing, drying, and fixing (hardening) are performed thereon in this order.

Here, the delivery drums 126, 128, and 130 respectively include guide members 127, 129, and 131 each of which has a rib attached thereto, and are rotated by rotation of the rotation shaft in a state where holding claws 133, 135, and 137 provided at the leading end portions of the arms extending in a direction in which the arms face each other at 180 degrees with the rotation shaft interposed therebetween grip the leading end portions of the sheets of paper P, thereby conveying the sheets of paper P along the guide members (127, 129, 131) such that the back side of the recording surface is convex in a state where the tailing end portions of the sheets of paper P are free.

It should be noted that each of the delivery drums 126, 128, and 130 may grip the sheet of paper P by using a chain gripper, and may convey the sheet in a state where the back side is convex.

In each of the delivery drums 126, 128, and 130, there is provided a heated-air drying unit 202 which blows heated air to the recording surface (top surface) of the sheet of paper P facing the inside during the conveying.

In the vicinity of the entrance of the drawing drum 170 through which the sheet of paper P dried by the drying unit 202 is delivered from the first delivery drum 126 to the drawing drum 170, there is provided a medium pressing roller 204 which presses the sheet of paper P toward the medium holding surface of the drawing drum 170 in order to smooth the cockling of the sheet of paper P conveyed to the drawing drum 170.

In addition to the medium pressing roller 204, a drum temperature sensor 206, which detects a temperature of the drum, is provided around the drawing drum 170 or the drying drum 176 (in the embodiment, below each drum).

Further, an air temperature sensor 208 as a temperature sensor is provided above the second delivery drum 128 between the inkjet head 172 and the solvent drying device 178 which is provided on a downstream side of the inkjet head 172 in the conveying direction D. The air temperature sensor 208 detects a temperature (hereinafter referred to as an air temperature) of the air between the inkjet head 172 and the solvent drying device 178.

A dew condensation member 210, which allows moisture in air to condense and attach thereto, is provided between the inkjet head 172 and the solvent drying device 178 on each of both sides of the upstream side and the downstream side of the air temperature sensor 208 in the conveying direction D.

A dew condensation member 210A, which is one of the two dew condensation members 210, is provided above the second delivery drum 128 on the drawing drum 170 side. A dew condensation member 210B, which is the other one of the two dew condensation members 210, is provided above the second delivery drum 128 on the drying drum 176 side.

Axial flow fans 212 (air blowing sections), which blow air onto the dew condensation members 210A and 210B, are provided above the respective dew condensation members 210A and 210B.

<Details of Dew Condensation Member 210>

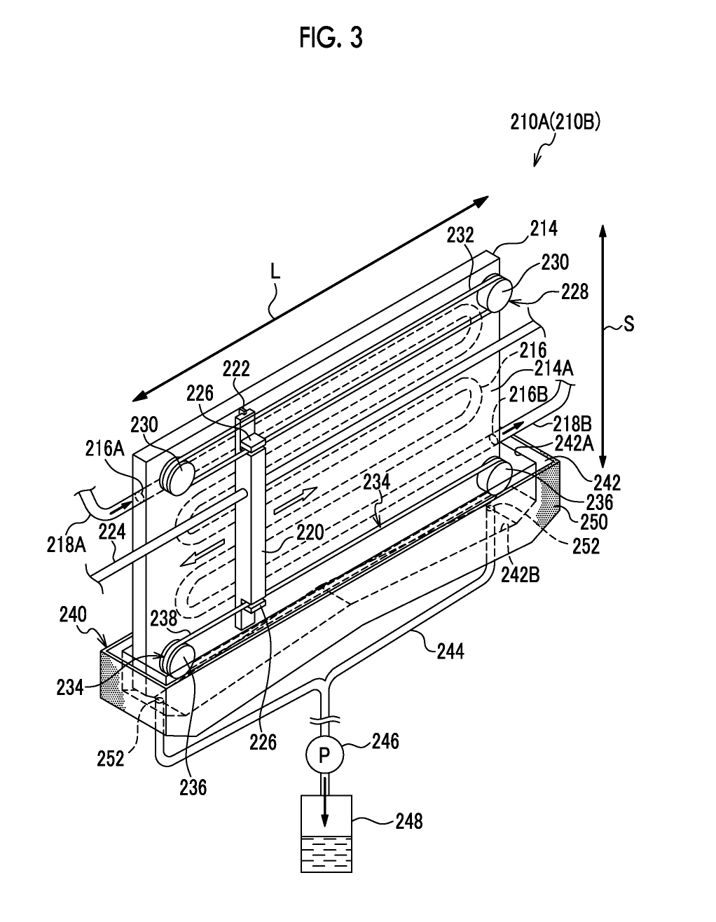

Next, the dew condensation member 210A will be described in detail. FIG. 3 is a perspective view of the dew condensation member 210A used in the inkjet recording apparatus 100 according to the first embodiment of the present invention. It should be noted that the dew condensation member 210B has the same configuration as the dew condensation member 210A to be described as follows, and thus a description thereof will be omitted.

The dew condensation member 210A has a plate 214 on which the moisture in air flowing from the drying section 118 to the drawing section 116 is condensed and which is formed in a rectangular plate shape. A material, which has a higher thermal conductivity than the constituent material of the inkjet head 172, is used as the constituent material of the plate 214 in order to increase the cooling effect of the plate 214 to be described later.

The plate surface 214A of the plate 214 is long in a right-left direction (in FIG. 2, a front-back direction) as viewed from the conveying direction D of the image forming apparatus 10, and the lengthwise direction L is orthogonal to the conveying direction D. Further, a widthwise direction S of the plate surface 214A is at a right angle to an installation surface IS (refer to FIG. 1) of the apparatus main body 200.

Inside the plate 214, a coolant passage 216 is formed as a cooling section which cools down the plate 214 by flowing water as a coolant over the entire plate 214. In the present embodiment, the coolant passage 216 extends through the plate 214 in a staggered manner.

An inlet 216A of the coolant passage 216 is provided on one side surface of the plate 214 orthogonal to the lengthwise direction L. The inlet 216A is connected to an inlet tube 218A (inlet pipe) through which water flows into the coolant passage 216. On the other hand, an outlet 216B of the coolant passage 216 is provided on the other one side of the plate 214 orthogonal to the lengthwise direction L. The outlet 216B is connected to an outlet tube 218B (outlet pipe) through which water flows out from the coolant passage 216.

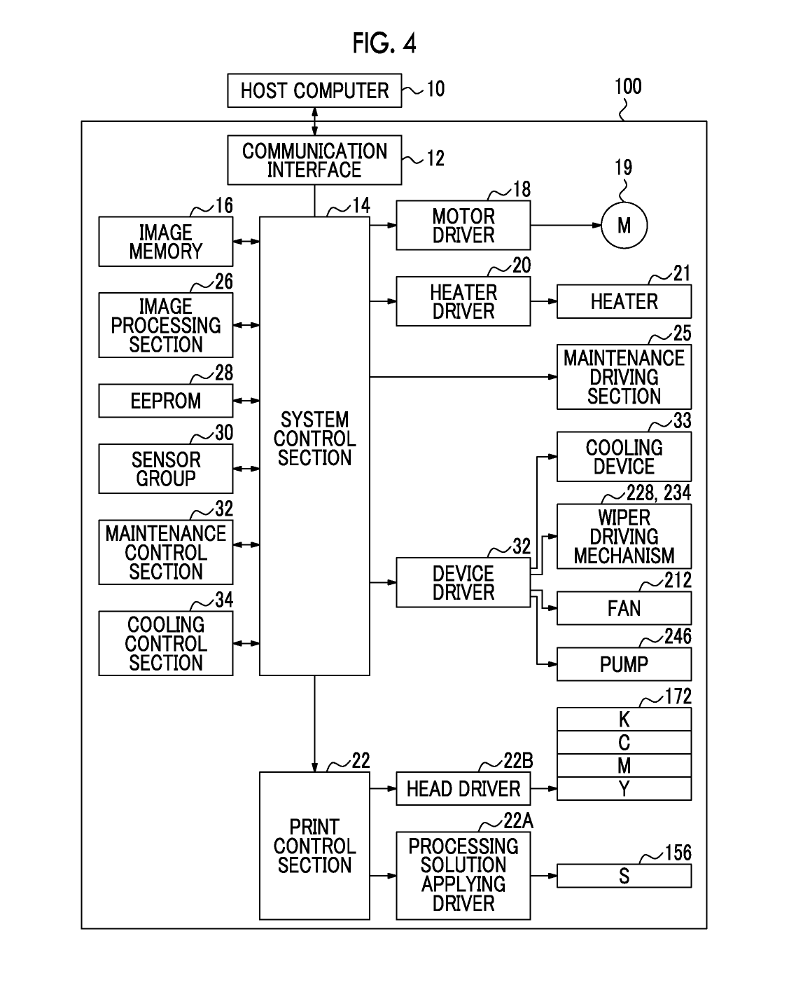

The inlet tube 218A and the outlet tube 218B are connected to a cooling device 33 (refer to FIG. 4) as a cooling section including a pump, a water storage section, and the like. The cooling device 33 causes water to flow from the water storage section not shown in the drawing to the inlet tube 218A and to discharge from the outlet tube 218B to the water storage section again by using a pump. Further, the cooling device 33 constantly cools down the water stored in the water storage section.

A wiper 220 is disposed along the widthwise direction S of the plate 214 on each of both plate surfaces 214A of the plate 214 (in FIG. 3, only the front side plate surface and wiper are shown). The wiper 220 has a rubber blade 222 which scrapes off the water droplets condensed on the plate surface 214A of the plate 214 and drops the water droplets to a receptacle to be described later.

Further, the wiper 220 is connected to a support rod 224 which is slidably fixed onto a not-shown internal frame of the image forming apparatus 10, thereby tightly pressing the blade 222 onto the plate surface 214A of the plate 214 with balance.

Supporting/fixing sections 226, each of which supports the wiper 220 and has a plate shape, are fixed onto both ends of the wiper 220, respectively. One supporting/fixing section 226 pinches an endless belt 232 of a wiper driving mechanism 228 to be described later between the supporting/fixing section 226 and the wiper 220, and is fixed onto the endless belt 232. The other supporting/fixing section 226 pinches an endless belt 238 of a wiper driving mechanism 234 to be described later between the supporting/fixing section 226 and the wiper 220, and is fixed onto the endless belt 232.

The wiper driving mechanism 228 has a power source not shown in the drawing, a pair of pulleys 230, and the endless belt 232.

The pair of pulleys 230 is provided on the two corners on the upper side of the inkjet recording apparatus 100 among the four corners of the plate surface 214A of the plate 214, and both the pulleys are rotated by the power source in the same direction. The single endless belt 232 can be wound around the pair of pulleys 230, and thus the single endless belt 232 is stretched between the pair of pulleys 230 along the lengthwise direction L.

Similarly to the wiper driving mechanism 228, the wiper driving mechanism 234 has a power source not shown in the drawing, a pair of pulleys 236, and the endless belt 238.

The pair of pulleys 236 is provided on the two corners on the lower side of the inkjet recording apparatus 100 among the four corners of the plate surface 214A of the plate 214, and both the pulleys are rotated by the power source in the same direction, and are rotated in an opposite direction to the pair of pulleys 230. The single endless belt 238 can be wound around the pair of pulleys 236, and thus the single endless belt 238 is stretched between the pair of pulleys 236 along the lengthwise direction L.

With such a configuration, the wiper driving mechanisms 228 and 234 circulate the endless belts 232 and 238 in directions opposite to each other, and switch the movement directions. Thereby, the wiper 220 reciprocates along the lengthwise direction L, with the supporting/fixing sections 226 which are in direct contact with the endless belts 232 and 238.

A discharge section 240, which discharges the water droplets condensed on the plate surface 214A of the plate 214 to the outside of the apparatus main body 200, is provided below the wiper 220.

The discharge section 240 has a receptacle 242, a discharge hose 244 (discharge pipe), a pump 246, and a reservoir can 248.

The receptacle 242 has a tray shape. That is, the receptacle 242 has a rectangular parallelepiped shape extending along the lengthwise direction L, in which an opening section 242A is formed on the wiper 220 side.

The outer surface of the receptacle 242 other than the side of the opening section 242A is covered with a heat insulation material 250 such as glass wool. Further, a receiving surface 242B, which receives water droplets separated from the plate surface 214A of the plate 214, that is, water droplets condensed on the plate surface 214A and running down from the plate surface 214A or water droplets scraped off by the wiper 220, is formed on the bottom of the opening section 242A.

The lower end of the plate 214 is inserted into the opening section 242A and is connected to the receiving surface 242B such that the receptacle 242 is also indirectly cooled down by the cooling of the plate 214. Thus, a material with a high thermal conductivity is used as a material of the receptacle 242 in a similar manner to the plate 214.

The receiving surface 242B is inclined downward from the center to both ends in the lengthwise direction L. Discharge spouts 252 are provided on the lower portions of the inclinations at both ends of the receiving surface 242B, respectively. Each discharge spout 252 is connected to a discharge hose 244 which discharges the water droplets of the receiving surface 242B to the outside of the apparatus main body 200.

The discharge hoses 244, which are connected to the respective discharge spouts 252, merge into one in the course of the path extending to the outside of the apparatus main body 200, and are subsequently connected to the pump 246. The pump 246 suctions water droplets on the receiving surface 242B from the discharge spouts 252 through the discharge hoses 244, and discharges the water droplets to the reservoir can 248 provided outside the apparatus main body 200.

The reservoir can 248 stores the water droplets which are discharged from the discharge hose 244, and disposes of the stored water droplets by releasing the connection with the pump 246.

<Effects>

Next, the effects of the inkjet recording apparatus 100 according to the first embodiment of the present invention will be described.

In the inkjet recording apparatus 100 according to the first embodiment, the moisture in air around the inkjet head 172 within the apparatus main body 200 is condensed on the dew condensation member 210. Thereby, dew condensation is inhibited from occurring on the nozzle surface of the inkjet head 172. Then, the water droplets, which are condensed on the dew condensation member 210, are discharged to the outside of the apparatus main body 200 by the discharge section 240. Thereby, the condensed water droplets are inhibited from remaining on the dew condensation member 210 and being vaporized again. Accordingly, compared with a case where the discharge section 240 is not provided, it is possible to inhibit dew condensation from occurring on the nozzle surface of the inkjet head 172.

In particular, in the inkjet recording apparatus 100 according to the first embodiment, the solvent drying device 178 dries the sheet of paper P onto which the ink is ejected. At this time, there is a concern that air, which includes moisture vaporized from ink or the sheet of paper P, may flow into the inkjet head 172 in a state where an amount of moisture of the air is larger than that of air on the upstream side of the inkjet head 172 in the conveying direction D.

Accordingly, in the present embodiment, the dew condensation member 210 is provided between the inkjet head 172 and the solvent drying device 178. Thereby, before the air, which includes moisture vaporized from ink or the sheet of paper P, flows up to the inkjet head 172, a large amount of the moisture in the air can be condensed on the dew condensation member 210, and can be removed.

In the dew condensation member 210, the plate 214 of the dew condensation member 210, on which the water droplets are condensed, is cooled down by the water flowing through the coolant passage 216. Hence, the moisture in air around the inkjet head 172 is condensed on the plate 214. In addition, the water droplets, which are condensed on the plate 214, are received by the receptacle 242, are discharged to the outside of the apparatus main body 200 through the discharge hose 244, and do not become stagnant in the apparatus main body 200.

The inkjet recording apparatus 100 has the wiper 220 that scrapes off the water droplets, which are condensed on the surface of the plate 214, and drops the water droplets to the receptacle 242. Therefore, it is possible to inhibit the condensed water droplets from remaining on the plate 214 and being vaporized again.

The inkjet recording apparatus 100 has an axial flow fan 212 that blows air on the dew condensation member 210. Thereby, in a similar manner to the water flowing through the coolant passage 216, the blown air cools down the dew condensation member 210, and the moisture in air flowing to the inkjet head 172 is condensed on the plate 214. Further, the air, which is indirectly cooled down by the cooling device 33, and the air within the apparatus main body 200 are circulated by the axial flow fan 212, and thus a large amount of air flows to the plate 214. Thereby, it is possible to promote dew condensation on the plate 214. Furthermore, the axial flow fan 212 blows air onto the plate 214 after the moisture is condensed on the plate 214, and is then able to blow the water droplets, which are condensed onto the plate 214, down onto the receptacle 242. Thereby, it is possible to inhibit the condensed water droplets from remaining on the plate 214 and being vaporized again.

The cooling device 33 is cooled down, whereby the receptacle 242 is also indirectly cooled down through the plate 214. Thereby, it is possible to inhibit the water droplets, which are collected on the receptacle 242, from being vaporized again by an increase in the temperature of the receptacle 242. Further, the outer surface of the receptacle 242 is covered with a heat insulation material 250. Therefore, dew condensation does not occur on the surface of the heat insulation material 250, and thus it is possible to inhibit the water droplets from dropping down to the sheet of paper P.

The receiving surface 242B for the water droplets is inclined, and the discharge hose 244 is configured to discharge the water droplets from a lower portion of the receiving surface 242B by using a pump 246. Thereby, the water droplets, which are received on the receiving surface 242B, flow and drop down to the lower portion due to the inclination of the receiving surface 242B, and flow toward the discharge hose 244. Then, by causing the pump 246 to suction the water droplets flowing toward the discharge hose 244, it is possible to promptly discharge the water droplets within the receptacle 242 through the discharge hose 244.

One of the two dew condensation members 210 is provided above the second delivery drum 128 on the drawing drum 170 side, on which the air flowing to the inkjet head 172 is concentrated, between the inkjet head 172 and the solvent drying device 178. Hence, it is possible to further condense the moisture in the air, which flows to the inkjet head 172, on the dew condensation member 210.

The water as a coolant flows through the coolant passage 216 formed inside the plate 214, thereby cooling down the area from the inside to the surface of the plate 214.

The plate surface 214A of the plate 214 is at a right angle to the installation surface IS of the apparatus main body 200. Hence, when the installation surface IS of the apparatus main body 200 is parallel with the ground surface, the installation surface IS is at a right angle to the plate surface 214A or the ground surface. Thus, it is possible to promote dropping of the water droplets which are condensed onto the plate 214.

### Second Embodiment

Hereinafter, referring to the accompanying drawings, an image forming apparatus according to a second embodiment of the present invention will be described in detail. It should be noted that, in the drawings, the members (components) having functions, which are the same as or correspond to the first embodiment, will be represented by the same reference signs and numerals, and description thereof will be appropriately omitted.

In the image forming apparatus according to the second embodiment of the present invention, a configuration of a control system of the inkjet recording apparatus 100, which is described in the first embodiment, will be described.

FIG. 4 is a principal block diagram illustrating a configuration of a control system of an inkjet recording apparatus 100 according to the second embodiment of the present invention.

The inkjet recording apparatus 100 has a communication interface 12 and a system control section (system controller) 14 that is connected to the communication interface 12.

The communication interface 12 is an interface section that receives image data sent from a host computer 10. A serial interface such as a universal serial bus (USB), IEEE1394, Ethernet (registered trademark), wireless network, or a parallel interface such as a Centronics can be used as the communication interface 12.

The system control section 14 is constituted of a central processing section (CPU) and peripheral circuits thereof, and the like, and the system control section 14 functions as a control device for controlling the whole of the inkjet recording apparatus 100 in accordance with a predetermined program, as well as a calculation device for performing various calculations. That is, the system control section 14 controls the various sections, such as the communication interface 12, a sensor group 30 to be described later, and a device driver 32, and generates control signals for controlling a heater 21 and a cooling device 33.

The system control section 14 is electrically connected to an image memory 16, a motor driver 18, a heater driver 20, a print control section 22, a maintenance control section 24, an image processing section 26, and an EEPROM 28.

The image memory 16 is storage means for temporarily storing the images inputted through the communication interface 12, and data is written and read through the system control section 14.

The image memory 16 stores the program executed by the CPU of the system control section 14 and the various types of data which is necessary for control.

The motor driver 18 drives a motor 19 in accordance with instructions from the system control section 14. In FIG. 4, the motors (actuators), which are disposed in the respective sections of the inkjet recording apparatus 100, are collectively represented by the reference numeral 19. For example, the motor 19 shown in FIG. 4 includes the motors which drive the intermediate conveying sections 126 and 128, the delivery drum 152, the processing solution drum 154, the drawing drum 170, the drying drum 176, the fixing drum 184, and the like, which are shown in FIG. 1.

The heater driver 20 drives the heater 21 in accordance with instructions from the system control section 14. In FIG. 4, a plurality of heaters arranged in the inkjet recording apparatus 100 are collectively represented by the reference numeral 21. For example, the heater 21 shown in FIG. 4 includes the heater of the processing solution applying section 114, the halogen heaters of the drying section 118, and the like shown in FIG. 1.

The print control section 22 has a signal processing function for carrying out various processing, such as shaping and correction, and the like, in order to generate a print control signal from the image data in the image memory 16, in accordance with the control of the system control section 14. Prior to the start of printing, the print control section 22 also controls a processing solution applying driver 22A so as to apply the processing solution onto the sheet of paper P from the processing solution coating device 156, as well as supplying the generated print data (dot data) to a head driver 22B. Predetermined signal processing is carried out in the print control section 22, and the volume of ejected ink droplets (ejection volume) and the ejection timing of the ink droplets in the inkjet head 172 are controlled through the head driver 22B on the basis of the image data. Thereby, the desired dot size and dot arrangement are achieved.

The maintenance control section 24 controls a maintenance driving section 25, which drives a maintenance unit (not shown) including a cap and a cleaning blade, through the system control section 14.

The image processing section 26 performs various kinds of image processing on the image data.

The EEPROM 28 is a storage section that stores various control programs and threshold values of the amount of liquid droplets, the humidity, and the temperature to be described later. The various control programs are read out from the EEPROM 28, and are executed, in response to the instruction from the system control section 14.

Other than the above-mentioned elements, the system control section 14 is electrically connected to the sensor group 30, the device driver 32, and a cooling control section 34.

The sensor group 30 includes the in-line sensor 190, the drum temperature sensor 206, and the air temperature sensor 208.

The device driver 32 is a driver that drives the cooling device 33, the wiper driving mechanisms 228 and 234, the axial flow fan 212, and the pump 246 in accordance with the instruction from the system control section 14.

The cooling control section 34 performs switching between the start and the stop of the cooling which is performed by the cooling device 33, on the basis of the amount of ink which is ejected from the inkjet head 172, the air temperature which is detected by the air temperature sensor 208, and the drum temperature which is detected by the drum temperature sensor 206. That is, the cooling control section 34 causes the cooling device 33 to start or stop flowing water into the coolant passage 216.

The cooling control section 34 also performs switching between start and stop of driving of the wiper driving mechanisms 228 and 234, the axial flow fan 212, and the pump 246, on the basis of the amount of ink, the air temperature, and the drum temperature. That is, the cooling control section 34 also corresponds to the wiper control section.

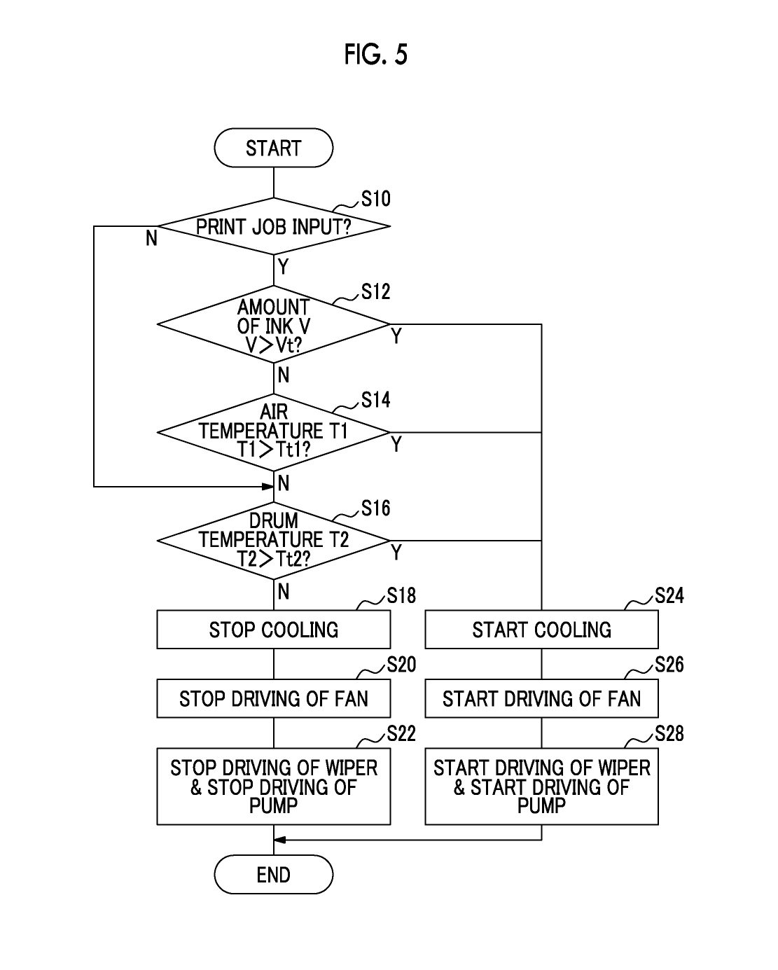

FIG. 5 is a flowchart illustrating a flow of a process of a cooling control section 34 executed at predetermined intervals (for example, every 0.1 seconds) in the inkjet recording apparatus 100. It should be noted that, in the following description, respective steps of the drawing are bracketed.

(S10) The cooling control section 34 determines whether or not a print job is input. Then, the cooling control section 34 advances to the process of step S12 if the determination result is positive, and advances to the process of step S16 if the determination result is negative.

(S12) The cooling control section 34 acquires the amount of ink V, which is ejected from the inkjet head 172, from the image information relating to the print job. Then, the cooling control section 34 determines whether or not the acquired amount of ink V is greater than the threshold value Vt. The cooling control section 34 advances to the process of step S24 if the determination result is positive, that is, if V>Vt, and advances to the process of step S14 if the determination result is negative.

(S14) The cooling control section 34 acquires the air temperature T1 between the inkjet head 172 and the solvent drying device 178. The air temperature T1 is detected by the air temperature sensor 208. Then, the cooling control section 34 determines whether or not the acquired air temperature T1 is greater than the threshold value Tt1. The cooling control section 34 advances to the process of step S24 if the determination result is positive, that is, if T1>Tt1, and advances to the process of step S16 if the determination result is negative.

(S16) The cooling control section 34 acquires the drum temperature T2 (the highest temperature of the drum temperatures) of the drawing drum 170 or the drying drum 176. The drum temperature T2 is detected by the drum temperature sensor 206. Then, the cooling control section 34 determines whether or not the acquired drum temperature T2 is greater than the threshold value Tt2. The cooling control section 34 advances to the process of step S24 if the determination result is positive, that is, if T1>Tt2, and advances to the process of step S18 if the determination result is negative.

(S18) The cooling control section 34 causes the cooling device 33 to stop cooling if the cooling device 33 is cooling down the dew condensation member 210, and advances to the process of step S20. Further, the cooling control section 34 directly advances to the process of step S20 if the cooling device 33 has stopped cooling.

(S20) The cooling control section 34 stops the driving of the axial flow fan 212 if the axial flow fan 212 is being driven, and advances to the process of step S22. Further, the cooling control section 34 directly advances to the process of step S22 if the driving of the axial flow fan 212 is stopped.

(S22) The cooling control section 34 stops the driving of the wiper driving mechanism 228 and the pump 246 if the wiper driving mechanism 228 and the pump 246 are being driven, and terminates the series of processes. Further, the cooling control section 34 directly terminates the series of processes if the driving of the wiper driving mechanism 228 and the pump 246 are stopped.

In addition, even after the cooling is stopped, the dew condensation member 210 is colder than the ambient air during a certain period of time, and thus dew condensation may occur on the dew condensation member 210. Consequently, it is preferable that the cooling control section 34 stop the driving of the wiper driving mechanism 228 and the pump 246 after an interval from the stop of the cooling.

(S24) The cooling control section 34 causes the cooling device 33 to start cooling if the cooling of the cooling device 33 is stopped, and advances to the process of step S26. Thereby, water flows through the coolant passage 216, the dew condensation member 210 is cooled down, and the moisture in air within the apparatus main body 200 is condensed on the plate 214 of the dew condensation member 210. In addition, at a timing at which the print job is input, that is, at a timing at which an image is formed on the sheet of paper P, the series of processes may be performed. In this case, the cooling control section 34 causes the cooling device 33 to start cooling before the solvent drying device 178 dries the sheet of paper P.

Further, the cooling control section 34 directly advances to the process of step S26 if the cooling device 33 is performing cooling.

(S26) The cooling control section 34 starts the driving of the axial flow fan 212 if the driving of the axial flow fan 212 is stopped, and advances to the process of step S28. Thereby, the water droplets, which are condensed onto the plate 214, are blown down onto the receptacle 242 through the air blowing of the axial flow fan 212, and the plate 214 is further cooled down.

Further, the cooling control section 34 directly advances to the process of step S28 if the axial flow fan 212 is being driven.

(S28) The cooling control section 34 starts the driving of the wiper driving mechanism 228 and the pump 246 if the result is positive in step S12 and if the driving of the wiper driving mechanism 228 and the pump 246 is stopped, and terminates the series of processes. Thereby, the water droplets, which are condensed onto the plate 214, are scraped off and dropped onto the receptacle 242 by the movement of the wiper 220, and are discharged from the receptacle 242 to the outside of the apparatus main body 200 through the discharge hose 244 by the suctioning of the pump 246.

Further, the cooling control section 34 directly terminates the series of processes if the wiper driving mechanism 228 and the pump 246 are being driven.

As described above, according to the inkjet recording apparatus 100 of the second embodiment of the present invention, when the amount of ink V is greater than the threshold value Vt, the cooling device 33 is switched to start cooling before the solvent drying device 178 dries the sheet of paper P. Thereby, before the air, which contains the moisture vaporized from the sheet of paper P or the ink, begins to flow to the inkjet head 172, the dew condensation member 210 is cooled down. As a result, compared with the case where the switching is made to start cooling after the sheet of paper P is dried, the air does not flow to the inkjet head 172 before the dew condensation on the dew condensation member 210.

In contrast, when the amount of ink V is equal to or less than the threshold value, the cooling device 33 is switched to stop cooling. Therefore, the cooling, which is performed by the cooling device 33, does not interfere with an increase in temperature of the drawing drum 170 facing the inkjet head 172.

Further, the driving of the wiper driving mechanisms 228 and 234 is started when the amount of ink V is greater than the threshold value Vt, and the driving of the wiper driving mechanisms 228 and 234 is stopped when the amount of ink V is less than the threshold value Vt. Thereby, compared with the case where the wiper 220 is constantly being driven, it is possible to inhibit wear of the wiper 220, particularly, the blade 222. Furthermore, even when the air temperature T1 or the drum temperature T2 is greater than each threshold value, the driving of the wiper driving mechanisms 228 and 234 is not started, and thus it is possible to further inhibit wear of the blade 222.

Further, when the air temperature T1 is greater than the threshold value Tt1, the cooling device 33 is switched to start cooling. Thereby, the high-temperature air flows from the solvent drying device 178 side to the inkjet head 172 side, and it is possible to inhibit drying of the nozzle surface of the inkjet head 172.

In contrast, when the air temperature T1 is less than the threshold value Tt1, there is less concern about the drying of the nozzle surface, and thus the cooling device 33 is switched to stop cooling. Thereby, it is possible to reduce energy consumed in the cooling.

Further, when the drum temperature T2 is greater than the threshold value Tt2, the cooling device 33 is switched to start cooling. Thereby, it is possible to cool down the drum when the drum is overheated. In addition, the temperature of the drawing drum 170 may be intended to be aggressively increased. In such a case, even when the drum temperature T2 is exceptionally greater than the threshold value Tt2, the cooling device 33 does not have to be switched to start cooling.

In contrast, when the drum temperature T2 is less than the threshold value Tt2, the cooling device 33 is switched to stop cooling. Thereby, it is possible to reduce energy consumed in the cooling.

### Third Embodiment

Hereinafter, referring to the accompanying drawings, an image forming apparatus according to a third embodiment of the present invention will be described in detail.

The image forming apparatus according to the third embodiment of the present invention has the same configuration as the inkjet recording apparatus 100, which is described in the first embodiment, except the dew condensation member.

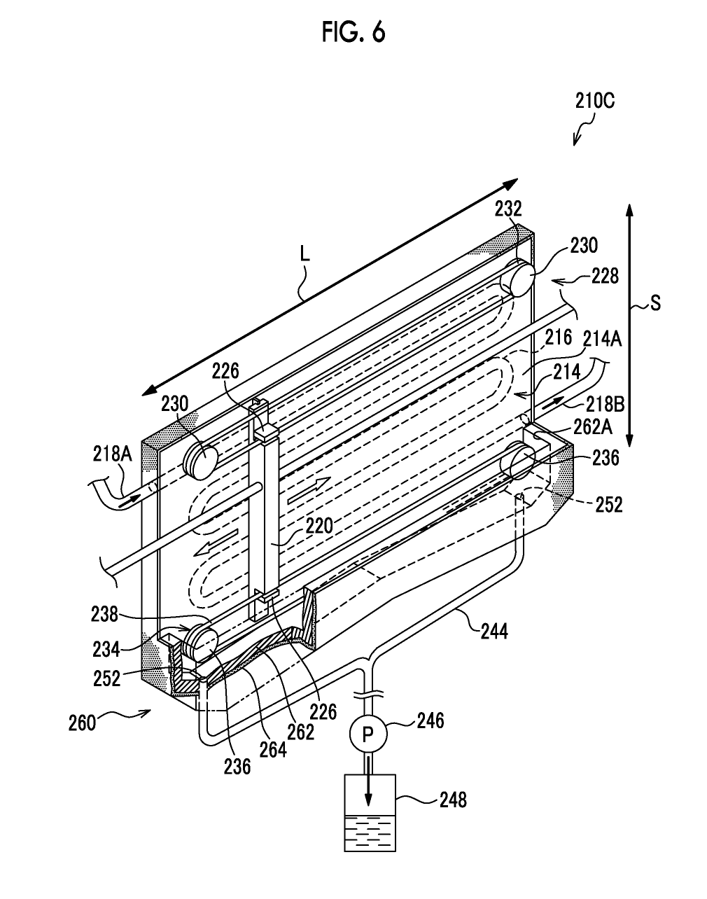

FIG. 6 is a perspective view of a dew condensation member 210C used in the image forming apparatus according to the third embodiment of the present invention.

The dew condensation member 210C has the plate 214 and the coolant passage 216, similarly to the dew condensation member 210A. Further, the wiper 220 is disposed on one plate surface 214A of the plate 214. The wiper 220 is reciprocated along the lengthwise direction L by the wiper driving mechanisms 228 and 234.

A discharge section 260, which discharges the water droplets condensed on the plate 214 to the outside of the apparatus main body 200, is provided below the wiper 220.

The discharge section 260 has a receptacle 262, the discharge hose 244, the pump 246, and the reservoir can 248.

In the receptacle 262, the plate member is formed in an L shape so as to extend from the lower end of the plate surface 214A, and the opening section 262A is formed on the wiper 220 side.

The outer surfaces of the receptacle 242 other than the opening section 242A side and the surfaces other than one plate surface 214A of the plate 214 are covered with a heat insulation material 264.

As described above, according to the dew condensation member 210C of the third embodiment of the present invention, the wiper 220 is disposed on only one plate surface 214A of the plate 214. Therefore, compared with the dew condensation member 210A in which the wipers 220 are disposed on both plate surfaces 214A, it is possible to reduce the entire size of the dew condensation member 210C, and it is possible to provide the dew condensation member 210C even at a location with a narrow space.

Further, the surfaces other than one plate surface 214A of the plate 214 are covered with the heat insulation material 264. Hence, the water droplets are inhibited from flowing and dropping down from the other surfaces.

### Fourth Embodiment

Hereinafter, referring to the accompanying drawings, an image forming apparatus according to a fourth embodiment of the present invention will be described in detail.

The image forming apparatus according to the fourth embodiment of the present invention has the same configuration as the inkjet recording apparatus 100, which is described in the first embodiment, except a part of the apparatus main body.

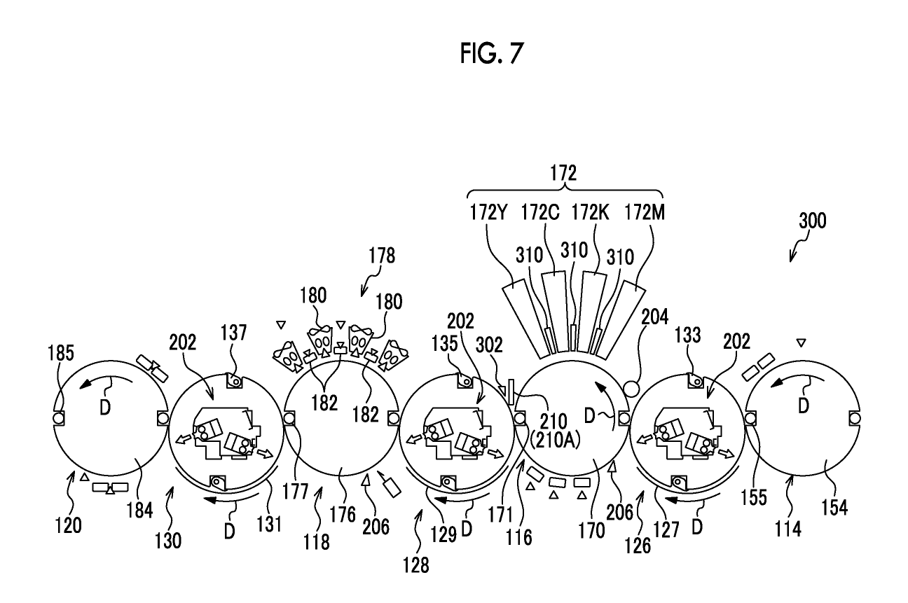

FIG. 7 is an enlarged side view of an apparatus main body 300 as a principal part of the image forming apparatus according to the fourth embodiment.

The apparatus main body 300 has the same configuration as the apparatus main body 200, but does not have the dew condensation member 210B and the axial flow fan 212, compared with the apparatus main body 200. Further, the apparatus main body 300 has a temperature and humidity sensor 302, which detects the humidity and the temperature between the inkjet head 172 and the solvent drying device 178, instead of the air temperature sensor 208.

In the apparatus main body 300, in addition to the dew condensation member 210A, a dew condensation member 310, which condenses the moisture in air, is provided between the inkjet head 172M and the inkjet head 172K.

Likewise, the dew condensation members 310 are also provided between the inkjet head 172K and the inkjet head 172C and between the inkjet head 172C and the inkjet head 172Y.

As described above, according to the image forming apparatus of the fourth embodiment of the present invention, the moisture in air is condensed on the dew condensation member 310. Here, the moisture contains the moisture vaporized immediately after the ink ejection. Therefore, it is possible to further inhibit dew condensation on the nozzle surface of the inkjet head 172.

Further, the apparatus main body 300 has the temperature and humidity sensor 302. With such a configuration, the cooling control section 34, which is described in the second embodiment, may perform switching between the start and the stop of the cooling of the cooling device 33, on the basis of the humidity which is detected by the temperature and humidity sensor 302, instead of the amount of ink which is ejected from the inkjet head 172.

### Modified Example

It should be noted that, although the present invention has been described in detail with reference to specific embodiments, the present invention is not limited to the embodiments mentioned above, it will be readily apparent to those skilled in the art that various embodiments can be made without departing from the scope of the present invention. In addition, the above-mentioned plural embodiments and modified examples can be appropriately combined.

For example, the first embodiment described the case where the wiper 220 is provided, but the wiper 220 may be removed. The reason is that the water, which is condensed on the plate 214, can be blown down onto the receptacle 242 by the axial flow fan 212 without the wiper 220.

Further, the axial flow fan 212 may also be removed together with the wiper 220. The reason is that, even in such a case, the condensed water droplets separate and drop from the plate surface 214 of the plate 214 when the plate surface 214A of the plate 214 has high water repellency or high hydrophilicity. The material of the plate 214 does not have to have water repellency or hydrophilicity, and the plate 214 may be coated with a water-repellent material or a hydrophilic material.

Furthermore, in order to regulate the direction in which the water droplets flow and drop, a vertical groove may be provided on the plate 214.

Moreover, the cooling device 33 may be removed. Even in such a case, when the plate 214 is formed of a material which has a higher thermal conductivity than the inkjet head 172 and by which dew condensation tends to occur, the moisture in air is condensed on the plate 214, thereby inhibiting dew condensation on the nozzle surface of the inkjet head 172. When the material of the inkjet head 172 is plastic, glass, ceramic, or silicone, the available material of the plate 214 is a material, which has a higher thermal conductivity than the above-mentioned materials, for example a metal material such as aluminum or copper.

In addition, in the above description, the receptacle 242 is indirectly cooled down by the cooling of the cooling device 33, but may be directly cooled down. That is, the coolant passage 216 may be provided inside the receptacle 242.

Further, in the above description, the wiper 220 may be reciprocated along the lengthwise direction L, but the wiper 220 may be rotated.

Furthermore, in the above description, one or two dew condensation members 210 are provided between the inkjet head 172 and the solvent drying device 178 (refer to FIGS. 2 and 7), but three or more dew condensation members 210 may be provided. Further, the dew condensation member 210 does not have to be provided between the inkjet head 172 and the solvent drying device 178 as long as the member is provided around the inkjet head 172. For example, the dew condensation member 210 may be provided upstream of the inkjet head 172 in the conveying direction D.

Moreover, examples of the cooling section, which cools down the dew condensation member 210, include water cooling means using the coolant passage 216, air cooling means including the axial flow fan 212, a Peltier device, and the like.

In addition, as the air blowing section which blows air onto the dew condensation member 210, a blowing section such as a centrifugal fan or a blower other than the axial flow fan 212 may be used. In addition, a compressed-air source, an air tube, an air blowing nozzle, a spray device, or the like may be used.

Further, the discharge section 240, which discharges the water droplets condensed on the dew condensation member 210 to the outside of the apparatus main body 200, may be configured such that the receptacle 242 or the pump 246 is removed from the configuration shown in FIG. 3.

Furthermore, as the conveying section which conveys the sheet of paper P, other than the cylinder (drum), a conveying roller or an electrostatic adsorption conveying belt, which keeps the sheet of paper P elestrostatically attached thereon and conveys the sheet of paper P, may be used.

In the above description, the cooling control section 34 controls not only the cooling device 33, but also controls all of the wiper driving mechanisms 228 and 234, the fan 212, and the pump 246. However, the cooling control section 34 may control only the cooling device 33. In this case, each device may be individually provided with a control section.

Further, the embodiment exemplifies the configuration of CMYK standard colors (four colors), but a combination of color numbers or ink colors is not limited to the embodiment, and a tint color ink, a concentrated ink, and a special color ink may be added as necessary. For example, a configuration, in which the inkjet head ejecting the light inks such as light cyan and light magenta may be added, is possible, and the order of arrangement of respective color heads is also not particularly limited.

Furthermore, the embodiment describes the example of the inkjet recording apparatus 100, which is the inkjet type using inks, as the image forming apparatus. However, the ejection liquid is not limited to inks for printing images and characters, and various ejection liquids (liquid droplets) may be applicable if the liquids use solvents or dispersion media capable of soaking into the sheet of paper P.

Moreover, in the embodiment, as the recording medium, the sheet of paper P is exemplified, but a recording medium such as yarn, fiber, textile, leather, metal, plastic, glass, wood, or ceramics, etc., and e.g., OHP may be used.

What is claimed is:

1. An image forming apparatus comprising:
a conveying section that is provided in an apparatus main body and conveys a recording medium;
a liquid droplet ejection head that ejects liquid droplets onto the recording medium which is conveyed by the conveying section;
a dew condensation member that is provided around the liquid droplet ejection head and allows moisture in air to condense thereon; and
a discharge section that discharges water droplets, which are condensed onto the dew condensation member, to an outside of the apparatus main body.

2. The image forming apparatus according to claim 1, further comprising a drying section that is provided downstream of the liquid droplet ejection head in a conveying direction of the recording medium and dries the recording medium onto which the liquid droplets have been ejected,
wherein the dew condensation member is provided between the liquid droplet ejection head and the drying section.

3. The image forming apparatus according to claim 2,
wherein the dew condensation member comprises a plate and a cooling section that cools down the plate, and
wherein the discharge section comprises a receptacle which receives the water droplets from a surface of the plate and a discharge pipe through which the water droplets in the receptacle are discharged to the outside of the apparatus main body.

4. The image forming apparatus according to claim 3, further comprising a wiper that scrapes off the water droplets, which are condensed onto the surface of the plate, and drops the water droplets to the receptacle.

5. The image forming apparatus according to claim 3, further comprising an air blowing section that is provided above the plate and blows air on the dew condensation member so as to blow the water droplets, which are condensed onto the dew condensation member, down to the receptacle.

6. The image forming apparatus according to claim 4, further comprising an air blowing section that is provided above the plate and blows air on the dew condensation member so as to blow the water droplets, which are condensed onto the dew condensation member, down to the receptacle.

7. The image forming apparatus according to claim 3, wherein the receptacle is cooled down by the cooling section, and an outer surface of the receptacle is covered with a heat insulation material.

8. The image forming apparatus according to claim 4, wherein the receptacle is cooled down by the cooling section, and an outer surface of the receptacle is covered with a heat insulation material.

9. The image forming apparatus according to claim 5, wherein the receptacle is cooled down by the cooling section, and an outer surface of the receptacle is covered with a heat insulation material.

10. The image forming apparatus according to claim 6, wherein the receptacle is cooled down by the cooling section, and an outer surface of the receptacle is covered with a heat insulation material.

11. The image forming apparatus according to claim 3,
wherein a receiving surface of the receptacle is inclined, and
wherein the discharge pipe suctions the water droplets from a lower portion of the inclined receiving surface by using a pump.

12. The image forming apparatus according to claim 3, further comprising a cooling control section that performs switching between start and stop of cooling performed by the cooling section, depending on an amount of liquid droplets ejected from the liquid droplet ejection head or a humidity between the liquid droplet ejection head and the drying section.

13. The image forming apparatus according to claim 12, further comprising
a temperature sensor between the liquid droplet ejection head and the drying section,
wherein the cooling control section performs switching between the start and the stop of the cooling performed by the cooling section, depending on a temperature which is detected by the temperature sensor.

14. The image forming apparatus according to claim 12,
wherein the conveying section comprises:
a drawing drum that conveys the recording medium by rotating while holding the recording medium, onto which the liquid droplets are ejected by the liquid droplet ejection head, on an outer circumferential surface thereof;
a delivery drum to which the recording medium on which drawing has been performed by the drawing drum is transferred; and
a drying drum that conveys the recording medium by rotating while holding the recording medium, which is transferred from the delivery drum and is dried by the drying section, on an outer circumferential surface thereof, and
wherein the dew condensation member is provided above the delivery drum on a side of the drawing drum.

15. The image forming apparatus according to claim 13,
wherein the conveying section comprises:
a drawing drum that conveys the recording medium by rotating while holding the recording medium, onto which the liquid droplets are ejected by the liquid droplet ejection head, on an outer circumferential surface thereof;
a delivery drum to which the recording medium on which drawing has been performed by the drawing drum is transferred; and
a drying drum that conveys the recording medium by rotating while holding the recording medium, which is transferred from the delivery drum and is dried by the drying section, on an outer circumferential surface thereof, and
wherein the dew condensation member is provided above the delivery drum on a side of the drawing drum.

16. The image forming apparatus according to claim 14,
wherein a drum temperature sensor that detects a drum temperature is provided around the drawing drum or the drying drum, and
wherein the cooling control section performs switching between the start and the stop of the cooling performed by the cooling section, depending on the drum temperature which is detected by the drum temperature sensor.

17. The image forming apparatus according to claim 4, further comprising a wiper control section that performs switching between start and stop of driving of the wiper, depending on an amount of liquid droplets ejected from the liquid droplet ejection head or a humidity between the liquid droplet ejection head and the drying section.

18. The image forming apparatus according to claim 2,
wherein the cooling section comprises:
a coolant passage which is formed inside the plate and through which a coolant flows;
an inlet pipe through which the coolant flows from the outside of the plate into the coolant passage; and
an outlet pipe through which the coolant flows out from the coolant passage to the outside of the plate.

19. The image forming apparatus according to claim 1,
wherein a plurality of the liquid droplet ejection heads are arranged in a conveying direction of the recording medium, and
wherein dew condensation members that allow moisture in air to condense thereon also provided between the plurality of the liquid droplet ejection heads.
